(19) United States
(12) Patent Application Publication
(10) Pub. No.: US 2022/0112402 A1
(43) Pub. Date: Apr. 14, 2022

(54) BONDING COMPOSITION FOR JOINING POLYMER COMPONENTS BY MATERIAL ENGAGEMENT

(71) Applicant: WOCO Industrietechnik GmbH, Bad Soden-Salmünster (DE)

(72) Inventor: Alexandra Lotz, Gelnhausen (DE)

(73) Assignee: WOCO Industrietechnik GmbH, Bad Soden-Salmünster (DE)

(21) Appl. No.: 17/498,292

(22) Filed: Oct. 11, 2021

(30) Foreign Application Priority Data
Oct. 9, 2020 (DE) 102020126608.1

(51) Int. Cl. C09J 5/06; C09J 121/00; C09J 11/04

(52) U.S. Cl. CPC C09J 5/06; C09J 2421/00; C09J 11/04; C09J 121/00

(57) ABSTRACT

A bonding composition joins polymer components by material engagement. The bonding composition includes a solvent and a polymer material, which may be made from similar polymers from which the polymer components are made. There may be a kit for producing a polymer components and a bonding composition. The polymer production includes volatilization of the solvent and optionally melting the polymer materials.

### RELATED APPLICATION

This application claims the benefit and priority of German Patent Application DE 10 2020 126 608.1, filed Oct. 9, 2020, which is incorporated by reference herein in its entirety.

### TECHNICAL FIELD

The application relates to a viscose or pasty bonding composition for joining two or more polymer components of the same or similar polymer structure by material engagement.

### BACKGROUND

The polymer parts to be produced can for example be structural and/or cover components in for example a motor vehicle, such as for example a media line and/or distributor, and actuator, battery encapsulation, headlight cover, or sealing or decoupling element.

In the prior art, many different joining processes for polymer parts exist. In particular, the functional components of technical thermoplastic, due to the high resilience of the connection areas, welding processes are applied. Hereby, the later geometry, the material requirements as well as component resiliency determine which welding process has to be applied, each of which have advantages and disadvantages. Thus, there is a fundamental requirement for a process improvement for connecting and particularly welding polymer components. For example, hot gas or infrared welding processes have the disadvantage, that they are technically as well as energetically very elaborate and require relatively long cycle times. Laser welding processes require specially adapted materials. A further alternative is the combined infrared and hot gas welding which, however, needs a very long process time to create a high-quality armor component. Further joining processes, such as vibration or rotation welding require post processing steps, in order to for example a certain that cleanliness requirements of the polymer parts are met. For ultrasonic welding, a prerequisite is a very high precision of the injection molded polymer parts which are to be connected. Altogether, the applicant is unaware of any universal connection process for polymer parts which is suitable for mass production or large-scale production. A further disadvantage of known connection processes lies in that only certain component geometries can be processed with the known joining processes.

From EP 3 527 639 A1 a process for joining a thermoplastic component with another material is known, in which an ionic liquid is applied between the two materials which are to be glued to one another and irradiated with microwaves so as to melt the thermoplastic material. The ionic liquid thereby realizes a microwave absorber delivering the necessary energy and heat for joining the two materials. In the process according to EP 3 527 639 A1, it is primarily disadvantageous that due to the required melting of the two adjacent interfaces of the materials, a possible connection goes along with a weakening of the final product, wherein, above all, the joining area realizes a weakening due to the encapsulated ionic liquid between the two materials. A further disadvantage persists due to the use of the ionic liquid which is very flowable and which has a higher surface tension and thus only remains between, and primarily on, the materials to be joined in a limited manner. Because of the high flow ability of the ionic liquid, furthermore, a very precise alignment of the materials to be glued is necessary, in particular the materials to be glued have to be positioned in a very small distance to one another or, in other words, the materials to be joined must have a high dimensional accuracy from the outset. Through the process according to EP 3 527 639 A1, furthermore, exclusively essentially parallelly oriented contact surfaces engaging one another, without any slot, may be joined. The geometry possibilities of the polymer parts to be produced thereby is very limited.

### SUMMARY

The embodiments relate to a viscose or pasty bonding composition for joining two or more polymer components of the same or similar polymer structure by material engagement. In some embodiments, a process and a kit are provided for producing a polymer component from two or more polymer components having the same or a similar polymer structure. In some embodiments, a motor vehicle component (including a cover component) may be included, such as a media line and/or a media distributor, actuator, a valve, battery encapsulation, headlight cover, or sealing and/or decoupling element.

An object of the present invention lies in overcoming the disadvantages of the prior art, in particular in providing a bonding composition and a production process with which any arbitrary component geometries can be joined using polymer components and/or with which the connection-or joining area between the two polymer components is reinforced.

Accordingly, a bonding composition, in particular a pasty bonding composition, was found for joining two or more, in particular two, polymer components by material engagement, each comprising or consisting of thermoplastic polymers, the precursors of duroplastic polymers, thermoplastic elastomers or elastomers, comprising at least one solvent and, completely or partially dissolved or dissolvable therein, one thermoplastic polymer material or a polymer material from thermoplastic elastomer or precursors of duroplastic polymer material or precursors for the polymer material of elastomers, each made of the same polymers from which the polymer components are made or which are contained therein, or made of polymers, which are at least partially miscible with the polymers from which the polymer components are made or which are contained therein. The miscibility can in particular be based on temperatures at which these polymers are in a melt-liquid or fluid state.

### BRIEF DESCRIPTION OF THE DRAWINGS

The figures illustrate principles of the invention according to specific embodiments. Thus, it is also possible to implement the invention in other embodiments, so that these figures are only to be construed as examples. Moreover, in the figures, embodiments, like any reference numerals, may correspond throughout the different drawings.

FIG. 1 illustrates a pressure pipe.

FIG. 2 illustrates a pulsation damper.

FIG. 3 illustrates an air distributor.

FIGS. 4a, 4b, 4c, and 4d illustrate connection of two parts at a joint.

FIGS. 5a, 5b, 5c, 5d, and 5e illustrate connection of two parts at a surface.

### DETAILED DESCRIPTION OF THE EMBODIMENTS

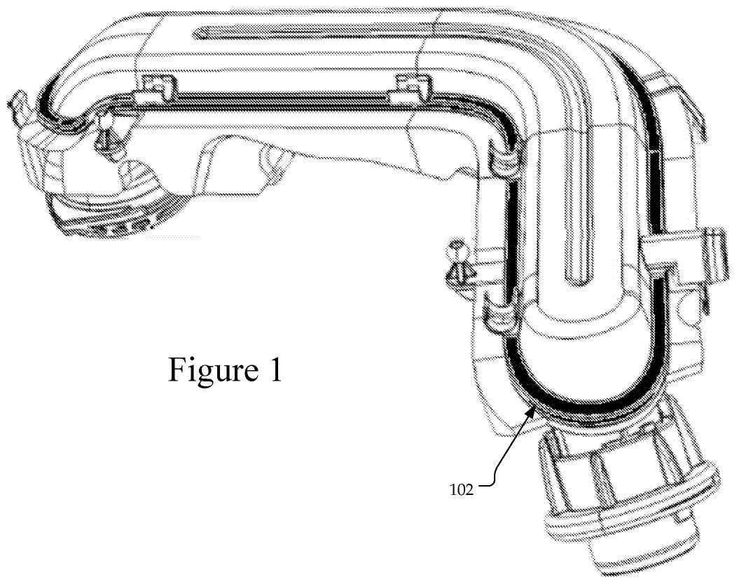

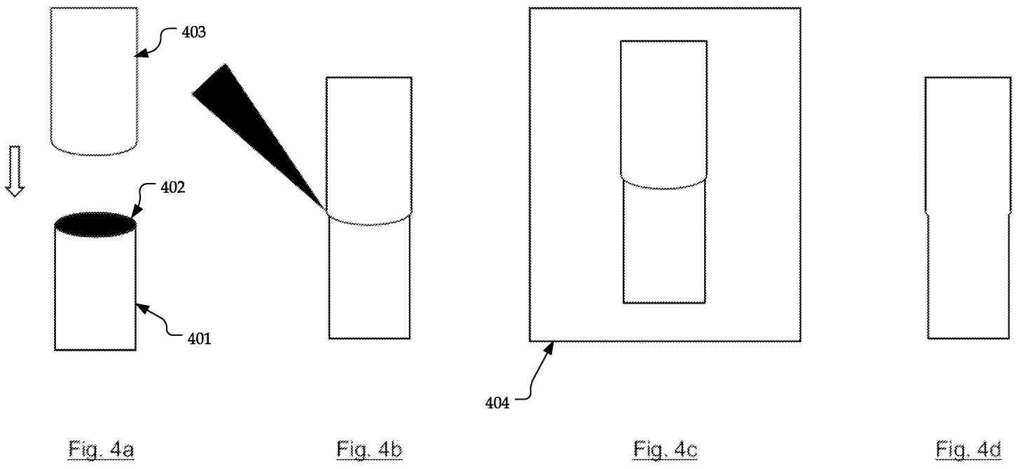

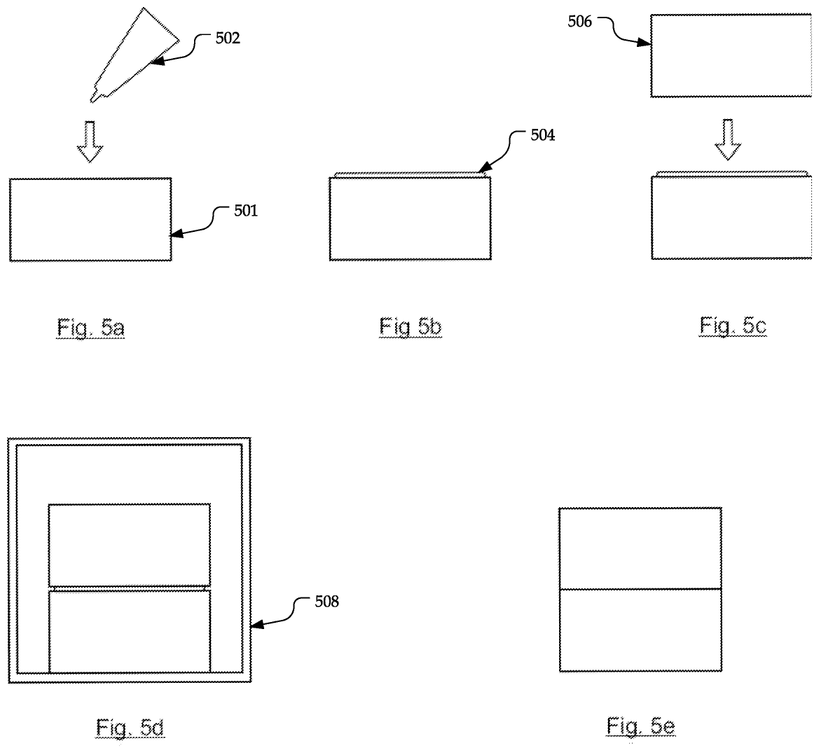

As an introduction, the present application and embodiments relates to a, in particular viscose or pasty, bonding composition for joining two or more polymer components of the same or similar polymer structure by material engagement. In some embodiments, a process and a kit are provided for producing a polymer component from two or more polymer components having the same or a similar polymer structure. FIGS. 1-3 illustrate three examples with polymer components joined by a bonding composition. FIGS. 4a-5e illustrate an example combination of polymer components.

FIG. 1 illustrates a pressure pipe. The pressure pipe is an example of a component with polymer parts connected with a bonding composition or paste. Specifically, the pressure pipe includes parts that are joined together along the surface 102 by a paste.

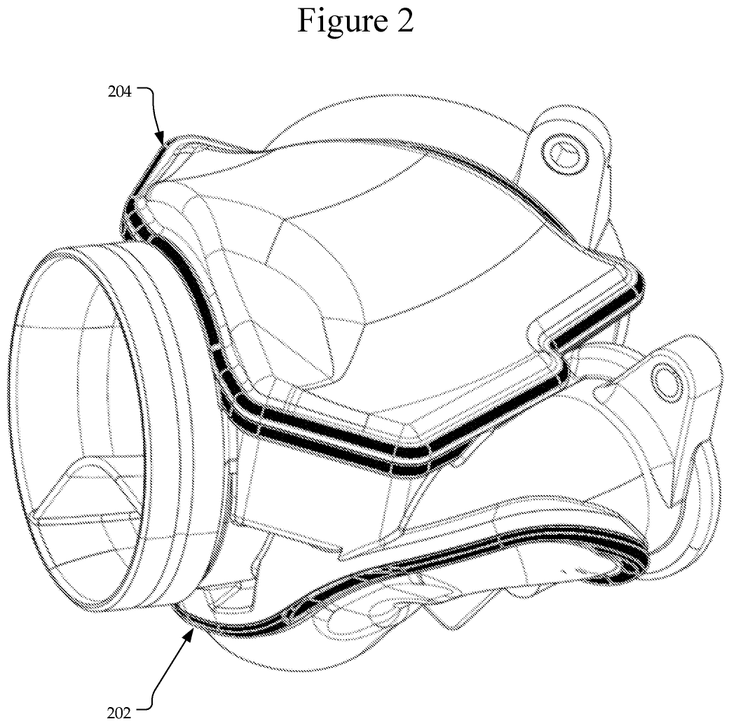

FIG. 2 illustrates a pulsation damper. The pulsation damper is an example of a component with polymer parts connected with a bonding composition or paste. Specifically, the pulsation damper includes parts that are joined together along the seams 202, 204 by a bonding composition or paste.

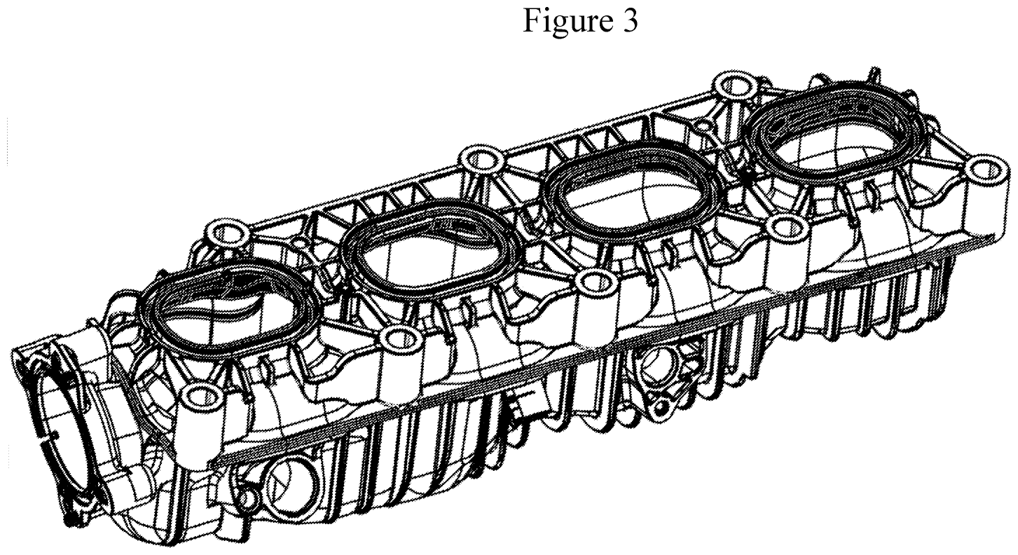

FIG. 3 illustrates an air distributor. The air distributor is another example of a component with polymer parts connected with a bonding composition or paste.

FIGS. 4a, 4b, 4c, and 4d illustrate connection of two parts at a joint.

FIG. 4a illustrates putting together the joining parts. A first joining part 401 and a second joining part 403 are combined at a surface with a bonding composition 402.

FIG. 4b illustrates application of the joint bonding composition (i.e. paste) on a joint (groove or gutter). This illustrates the two joining parts from FIG. 4a combined at the joint or seam.

FIG. 4c illustrates a component held in position with a microwave reactor 404 irradiated and heated at the joint. The microwave reactor 404 heats the parts to seal the bonding composition.

FIG. 4d illustrates that after cooling, the component is finished and attached. The two joining parts are joined together.

FIGS. 5a, 5b, 5c, 5d, and 5e illustrate connection of two parts at a surface.

FIG. 5a illustrates a bonding composition (e.g. paste) 502 being applied to a joining part 501.

FIG. 5b illustrates the joining part with the viscose bonding composition that does not run off the part. The bonding composition 504 is spread on the surface of the joining part 501.

FIG. 5c illustrates application of a second part to the joining part with the paste. A second joining part 506 is combined with the first joining part 501.

FIG. 5d illustrates the joined parts by the paste being held in a microwave reactor 508 for irradiation and heat. The heat attaches the two joining parts with the bonding composition.

FIG. 5e illustrates that after cooling, the component is finished and the two parts are attached.

In one embodiment the polymer parts may be thermoplastic polymers, the precursors of duroplastic polymers, thermoplastic elastomers or elastomers contain polar functional groups. by using polar functional groups, the mentioned polymers or mentioned precursors contained in the bonding composition can be provided with an improved sensitivity with respect to microwave radiation and be transferred, in particular under the component surface, into the melt-liquid state particularly effectively.

For the solvent of the bonding composition according to one embodiment, polar solvents may be utilized. Particularly solvents can thereby be selected from the group consisting of ketones, in particular acetones, cyclohexanone, cyclopentanone, 2-pentanone, 3-pentanone, methyl isobutyl ketone and/or methyl ethyl ketone; lactones in particular γ-butyrolactone, lactams in particular N-methyl-2-pyrrolidone, nitriles in particular acetonitrile, propane nitrile and/or benzonitrile; nitro compounds, in particular nitroalkanes, e.g. nitromethane, nitroethane, nitropropane and/or nitrobutane, carboxamides, in particular dimethylformamide, N-methylformamide, formamide, hexamethylphosphoric triamide and/or dimethylacetamide, urea derivatives, in particular tetramethylurea and/or dimethylpropyleneurea, sulfoxides, in particular dime-thyl sulfoxide, sulfones, in particular sulfolane; carboxylic acids, in particular C1- to C10-alkanoic acids, e.g. for example formic acid, acetic acid and/or propionic acid, carboxylic esters of formic acid, acetic acid, propionic acid and/or terephthalic acid, in particular ethyl acetate, isopropyl acetate, n-propyl acetate, t-butyl acetate, n-butyl acetate, octyl acetate, ethyl propionate; anhydrides of formic acid, acetic acid, propionic acid and/or terephthalic acid, in particular ethyl acetate, isopropyl acetate, n-propyl acetate, t-butyl acetate, n-butyl acetate, octyl acetate, ethyl propionate; anhydrides of formic acid, acetic acid, propionic acid and/or terephthalic acid; carbonates, in particular dimethyl carbonate, diethyl carbonate and/or propylene carbonate; alcohols, in particular ethanol, methanol, 1-butanol, 2-butanol, t-butanol, 2-propanol, 1-propanol, 2-methoxyethanol, tetrahydrofuryl alcohol, benzyl alcohol, isoamyl alcohol, 2-pentanol, 2-ethylhexanol and/or cyclohexanol; polyalcohols, in particular glycerol, ethylene glycol, propylene glycol, 1,4-butanediol, 1,2-propanediol, 1,3-propanediol, di-propylene glycol, diemethylene glycol and/or diethylene glycol, ether compounds of polyalcohols, in particular ethylene glycol dimethyl ether; aldehydes, in particular furfural; substituted aromatics, in particular chlorobenzene, dichlorobenzene, dinitrobenzene, nitrobenzene, quinoline and/or pyridine, and any mixtures thereof, in each case optionally mixed with a minor amount of water.

Also through utilizing a polar solvent, frequently an effective interaction with microwave radiation may be achieved, whereby the bonding composition and the components contained therein as well as the polymer components with which the bonding composition is brought into engagement are heated and, insofar as desired, can be transferred into the melt-liquid or fluid state.

The in particular polar solvent thereby realizes in an embodiment a radiation absorber, in particular a microwave absorber. This may be configured to heat upon an exposure, in particular by means of microwaves, such that for example the partially undissolved polymer material present in the solvent at least sectionally changes into the melt-viscous or melt-liquid state. In some embodiments, the two or more polymer components to be joined are transferred at least in the area of the respective connection surfaces to be joined, into the melt-viscous or melt-liquid state through the use of the solvent as radiation absorber.

Bonding compositions according to one embodiment may in a further embodiment include one or more microwave absorbers.

Particularly microwave-absorbers for the bonding composition according to one embodiment are thereby selected from the group consisting of inorganic alkali metal salts, in particular sodium chloride, potassium fluoride and/or potassium iodide, optionally in combination with Al2O3; inorganic alkaline earth metal salts, in particular calcium chloride; alkali metal salts of carboxylic acids, in particular of alkanoic acids; alkaline earth metal salts of carboxylic acids, in particular of alkanoic acids; spinels, such as magnetite and in particular CuNi0.5Mn1.5O4, V2O5 and/or Al2O3; metal powders, in particular Ni, Fe and/or Co; carbon black; silicon carbide; fullerenes; carbon nanotubes; graphite; graphene; activated carbon; organic fillers, in particular viscose fibers, tartaric acid, the salts of tartaric acid and/or xylitol; and their arbitrary mixtures. the use of such microwave-absorber us is often recommendable when nonpolar solvents are used in the bonding compositions according to one embodiment.

In alternative embodiments, accordingly, also for the bonding compositions according to one embodiment a nonpolar solvent can be relied upon, in particular being selected from the group consisting of aromatic solvents, in particular toluene, xylene and/or benzene, aliphatic solvents, in particular cyclohexane, hexane, heptane and/or pentane, ethereal solvents, in particular diethyl ether and/or tetrahydrofuran, chlorinated solvents, in particular dichloromethane, chloroform and/or dichloroethane, fluorinated solvents, in particular perfluorohexane and their arbitrary mixtures.

The selection of the solvent is hereby not insignificantly dependent upon the polarity or lack of polarity of the polymers of the polymer components to be joined, as well as in particular from the polarity or lack of polarity of the polymer material of the bonding composition according to one embodiment. Thereby, the solvent is appropriately to be selected such that, that the polymer material and/or the polymers of the polymer components to be joined are at least partially dissolved at a temperature wherein the solvent remains always fluid.

The amount of solvent is in the bonding components according to one embodiment selected such that it is sufficient for wetting the polymer material completely, which the polymer material is in particular present or applied in granules or powder form.

Dependent upon the temperature -dependent dissolution-characteristics of the polymer materials in the solvent/solvents of the bonding composition according to one embodiment, the same may be a suspension or a solution.

The bonding composition may comprise a viscosity, determined according to DIN EN ISO 3219:1994-10 at a temperature of 20° C., in the range of 103 mPas to 8×106 mPas.

The bonding composition according to one embodiment is configured and adapted such that the two or more polymer components can be joined by material engagement upon a volatilization of the solvent at a predetermined temperature, in particular room temperature. hereby it may in particular be provided that the polymer material of the bonding composition is adapted to the thermoplastic polymers, the duroplastic polymers, the thermoplastic elastomers or the elastomers of the polymer components to be bonded such that, upon a volatilization of the solvent at a predetermined temperature, in particular room temperature, the two polymer components can be joined by material engagement.

The thermoplastic polymer material of the bonding composition according to one embodiment and/or the thermoplastic polymers of the polymer components which are to be joined can be selected from the group consisting of polyolefins, in particular polyethylene and/or polypropylene, polyamides, polyimides, polyetherimides, polyethers, polysulfones, polyetherpolyurethanes, polyether sulfones, polyetherketones, polyketones, polyesters, polyacrylates, in particular polymethyl methacrylate, polyvinyl chloride, polyvinylidene difluoride, polycarbonate, acrylonitrile/butadiene/styrene copolymers and their arbitrary mixtures, or that the duroplastic polymer material or the duroplastic polymers of the polymer parts to be joined is selected from the group consisting of epoxy resins, methacrylate resins, phenolic resins, polyester resins, e.g. unsaturated polyester resins, polyurethane resins, e.g. two-component polyurethane foams, vinyl ester resins, e.g. unsaturated vinyl ester resins, crosslinked, in particular radiation crosslinked, thermoplastics, e.g. radiation crosslinked polypropylene and their arbitrary mixtures, or that the polymers of the thermoplastic elastomers and/or the polymer material of the thermoplastic elastomers is selected from the group consisting of thermoplastic elastomers based on ethylene-vinyl acetate copolymers; polyhydroxybutyrate; polylactides; polyetherimides; polyoxymethylene; polycarbonates; polystyrene; impact-modified polystyrene; styrene-based copolymers, in particular ABS, SAN, PS, HIPS, ASA and/or SEBS; olefin-based thermoplastic elastomers, in particular LLD-PE, EOC, TPV and/or EVA; PE/polyester-based thermoplastic elastomers; urethane-based thermoplastic elastomers; polyether block amides; PVC; polyurethanes, in particular thermoplastic polyurethanes, and thermoplastic starch and their arbitrary mixtures, or that the polymers of the elastomers and/or the polymer material of the elastomers are elastomers selected from the group consisting of acrylonitrile/butadiene/acrylate copolymers, acrylonitrile/chlorinated polyethylene/styrene copolymers, acrylonitrile/methyl methacrylate copolymers, ethylene-ethyl acrylate copolymers, ethylene-propylene copolymers, ethylene-propylene-diene copolymers, vinyl chloride/ethylene copolymers, vinyl chloride/ethylene/methacrylate copolymers, polyisobutylene, polyvinyl butyral, butadiene rubber, butyl rubber, chloroprene rubber, fluororubber, isoprene rubber, natural rubber, silicone rubber, styrene-butadiene rubber and their arbitrary mixtures, in particular based on polyethylene, polypropylene, polyamides, polyethylene terephthalate or polybutylene terephthalate.

For the polymer material of the bonding composition, according to one embodiment, an uncrosslinked rubber or an uncrosslinked rubber mixture or an uncrosslinked precursor of a duroplast is used.

Of particular advantage or herein such bonding composition according to one embodiment, in which the thermoplastic polymers or the duroplastic polymers or the polymers of the thermoplastic elastomers or the polymers of the elastomers of the polymer components match in each case and/or in which the thermoplastic polymer or duroplastic polymer or the polymer of the thermoplastic elastomer or the polymer of the elastomer of the polymer components and the thermoplastic polymer material of the bonding composition according to one embodiment, the precursor of the duroplastic polymer material, the polymer material of the thermoplastic elastomers or the polymer of the elastomer precursor of the bonding composition match in each case. Hereby, polymers miscible in their melt-liquid state are frequently obtained.

For many different applications it has surprisingly proven to be advantageous, in particular when connected polymer components shall be obtained with a very pronounced mechanical stability also in the connection area, that the thermoplastic polymer, the duroplastic polymer, the polymer of the thermoplastic elastomers or the polymer of the elastomers of at least one polymer component and/or, the thermoplastic polymer material, the duroplastic polymer material, the polymer material of the thermoplastic elastomers or the polymer material of the elastomers or the precursors of the duroplastic polymer material or the precursor for the polymer material of elastomers in the bonding composition comprise or comprises fibers, in particular glass fibers.

Suitable thermoplastic polymers which can be used as polymer materials for the bonding composition according to one embodiment as well as also for the polymer components to be joined comprise also such with nonpolar functional groups. These include thermoplastic polymers with nonpolar functional groups, in particular for the polymer components to be joined, which is selected from the group consisting of polyolefins, in particular polyethylene and/or polypropylene, polybutene, polyisobutene, polyetherketones, in particular PEK, PEEK, polyethylene terephthalate, polybutylene terephthalate, polyphenylene sulfide, polyphenylene sulfones, polyacetal, in particular polyoxymethylene, polystyrene, polytetrafluoroethylene and their arbitrary mixtures

As a nonpolar thermoplastic polymer for the bonding composition according to one embodiment, in particular polyolefins, e.g. polyethylene and/or polypropylene , into consideration. Herein, the solvent having a permittivity (at 25° C.) smaller than 15, smaller 10 and/or smaller 5 is used. Bonding composition according to one embodiment provided with the previously specified nonpolar thermoplastic polymers , comprise at least one microwave-absorber, in particular in an amount in the range of 0.01 to 5 wt.-%, in the range of 0.1 to 1.0 wt.-%, in each case in relation to the amount of polymer material.

The polymer material, in particular the thermoplastic polymer material, of the bonding composition according to one embodiment is included as granules and/or in powder form into this bonding composition.

For a bonding composition embodiment, thermoplastic high temperature polymer material is used as the thermoplastic material. This may thereby be selected from the group consisting of polyetheretherketones, polyetherketones, polyimides, polyamideimides, poly sulphones, polyethersulphones, polyvinylidene difluoride, polyphenylene sulphones, polyphenylene sulphide and/or polyacetals. Herein, the solvent frequently has a permittivity (at 25° C.) greater than or equal 15, in particular greater than or equal 20, and/or, realizes a protonic solvent, in particular carboxylic acid. Bonding composition according to one embodiment provided with the previously specified thermoplastic high temperature polymer materials are essentially free of microwave-absorbers aside from the solvent as a possible microwave absorber.

In the bonding components and in particular in the polymer components to be joined, the duroplastic polymers are provided in particular as partially cross-linked duroplastic polymers, with a crosslinking degree of maximum 80%, more with a crosslinking degree of maximum 70%. alternatively and in particularly additionally it may thereby be provided, that the duroplastic polymer material realizes partially crosslinked duroplastic material, having a crosslinking degree of maximum 80%, having a crosslinking degree of maximum 70%. furthermore, in some embodiments, it may be provided that the precursors of the duroplastic polymer material are present uncrosslinked.

When elastomers are used as the polymer material of the bonding composition according to one embodiment, these have a cross-linking degree, determined according to DIN 16892:2019-10, not above 60%, or not above 50%.

In one embodiment of the bonding composition according to one embodiment it may be provided that the polymer material is or comprises, in a major amount, at least one thermoplastic polymer, in particular polyamide and/or PEEK, and wherein the solvent is or comprises a C1 to C6 alkanoic acid, in particular methanoic acid, in admixture with a minor amount of water.

In a further embodiment of the bonding composition according to one embodiment, it may be provided, that the polymer material, in a minor amount, is or comprises polytetrafluoroethylene and/or polyvinylidene difluoride and wherein the solvent is or comprises a fluorinated solvent, in particular perfluorohexane, or dimethylformamide.

In a further embodiment of the bonding composition according to one embodiment it may further be provided that the polymer material, in a major amount, is or comprises polyether polyurethane and wherein the solvent is or comprises diemthylformamide, dimethylacetamide and/or acetone.

In a further embodiment of the bonding composition according to one embodiment it may additionally be provided that the polymer material comprises or is, in a major amount, at least one non-polar thermoplastic polymer, in particular polyethylene and/or polypropylene, and wherein the solvent comprises hexane, heptane and/or cyclohexane.

also, in a further embodiment of the bonding composition according to one embodiment it may be provided that the polymer material, preferably in a major amount, is or comprises at least one nonpolar thermoplastic polymer, in particular polystyrene, and wherein the solvent is or comprises acetone.

Finally, in a further embodiment of the bonding component according to one embodiment it may be provided that the polymer material, preferably in a major amount, comprises or represents polymethyl methacrylate and/or polycarbonate and wherein the solvent comprises or represents nitroalkanes, in particular nitromethane, nitroethane, nitropropane and/or nitrobutane, acetone, dichloromethane, ethyl acteate, n-propyl and n-butyl acetate, toluene and/or xylene.

Of the bonding composition's according to one embodiment are ones which comprise at least 5 wt.-%, preferably at least 10 wt.-%, at least 30 wt.-%, or 5 to 99 wt.-%, 20 to 88 wt.-% and/or 30 to 75 wt.-%, with respect to the total weight of the bonding composition, respectively, thermoplastic polymer material, polymer material of thermoplastic elastomers and/or polymer material of elastomers or of precursors of a duroplastic polymer material or precursors for the polymer material of elastomers, wherein components of the bonding composition always amount to 100.0 wt.-%. Herein it may alternatively or additionally, in particular additionally, be provided that the solvent has a composition fraction with respect to the total weight of the bonding composition in the range of 1 wt.-% to 90 wt.-%, in particular 5 wt.-% to 80 wt.-% or of 10 wt.-% to 75 wt.-%, wherein components of the bonding composition always amount to 100.0 wt.-%.

Some embodiments of the bonding composition according to one embodiment are also characterized in they comprise at least 5 wt.-%, at least 10 wt.-%, and/or at least 30 wt.-%, in each case based on the total weight of the bonding composition, of thermoplastic polymer material dissolved in the solvent, of precursor of durpolasts, duroplastic polymer material, polymer material of thermoplastic elastomers, polymer material of precursors of elastomers and/or polymer material of elastomers, wherein components of the bonding composition always amount to 100.0 wt.-%. Herein it may alternatively or additionally, in particular additionally, be provided that the solvent contains a proportion by weight, based on the total weight of the compound composition, in the range from 1 wt.-% to 90 wt.-%, in particular from 5 wt.-% to 80 wt.-% or from 10 wt.-% to 75 wt.-%, the components forming the compound composition always adding up to 100.0 wt.-%.

Particularly useful embodiments of the bonding compositions according to one embodiment are also characterized in that they contain at least 5 wt.-%, at least 10 wt.-% and/or at least 30 wt.-%, in each case based on the total weight of the bonding composition, of thermoplastic polymer material dissolved in the solvent, of the precursor of a thermoset, polymer material of thermoplastic elastomers and/or polymer material of precursors of elastomers, or at least 5 wt.-%, at least 10 wt.-% and/or at least 30 wt.-%, in each case based on the total weight of the bonding composition, of precursors of the thermoset polymer material dissolved in the solvent and/or dissolved precursors of elastomers. %, at least 10 wt.-% and/or at least 30 wt.-%, in each case based on the total weight of the bonding composition, of precursors of the duroplast or thermoset polymer material dissolved in the solvent and/or dissolved precursors for the polymer material of elastomers.

The object on which the invention is based is furthermore solved by a kit for producing a polymer part, in particular a motor vehicle component, such as a cover component, a media line and/or a media distributor, actuator, battery encapsulation, headlight cover or sealing and/or decoupling element, comprising at least one first polymer component, which is in particular formed as described above in conjunction with the bonding compositions according to one embodiment, and at least one second polymer component, which is also formed as described above in conjunction with the bonding compositions according to one embodiment , in particular according to one of the preceding claims, each comprising or formed from thermoplastic polymers or duroplastic polymers or thermoplastic elastomers or elastomers, and a bonding composition according to one embodiment , formed according to one of the preceding claims, for joining the first and second polymer or further components by material engagement.

The object on which the invention is based is furthermore solved by a kit for producing a polymer part, in particular a motor vehicle component, such as a cover component, a media line and/or a media distributor, actuator, battery encapsulation, headlight cover or sealing and/or decoupling element, comprising at least one first and at least one second polymer component, each comprising or formed from thermoplastic polymers, and a bonding composition, in particular a bonding composition as described above, for joining said first and second polymer components, said joining composition comprising at least one polar solvent and an amount of at least one thermoplastic polymeric material having polar functional groups, said amount of said at least one thermoplastic polymeric material being completely or partially dissolved in said at least one polar solvent.

Additionally, the object on which the invention is based is furthermore solved by a kit for producing a polymer part, in particular a motor vehicle component, such as a cover component, a media line and/or a media distributor, actuator, battery encapsulation, headlight cover or sealing and/or decoupling element, comprising at least one first and at least one second polymer component, each comprising or formed from thermoplastic polymers, and a bonding compound, in particular a bonding component according to one embodiment , for bonding the first and second polymer components, the bonding compound comprising at least one non-polar solvent, an amount of at least one thermoplastic polymeric material having non-polar functional groups, said amount of said at least one thermoplastic polymeric material being completely or partially dissolved in said at least one non-polar solvent and/or at least one microwave absorber, in particular potassium fluoride, graphite, graphene, carbon black, carbon nanotubes, activated carbon, viscose fibers, tartaric acid, the salts of tartaric acid, NiZn ferrite, metal salts of the polymer components and/or metal salts of the solvent.

The object on which the invention is based is furthermore solved by a process for producing a polymer part, in which at least one first and at least one second polymer component, each comprising or formed from thermoplastic polymers, duroplastic polymers, thermoplastic elastomers or elastomers, are provided, and a bonding composition according to one embodiment, in particular a pasty composition, is introduced between and/or applied to respective bonding surfaces of the polymer components, wherein the bonding mass comprises at least one solvent and a thermoplastic polymer material or polymer material of thermoplastic elastomers or polymer material of uncrosslinked elastomer precursors of the same polymers of which the polymer components are formed or which are contained therein, dissolved therein completely or in parts, or of polymers which are at least partially miscible with the polymers from which the polymer components are formed or which are contained therein, wherein a bond between the first polymer component, the polymer material of the bonding composition and the second polymer component is effected by volatilization of the solvent.

With the process according to one embodiment two or more, in particular two, polymer components can be joined by material engagement.

Hereby, the volatilization of the solvent occurs at a predetermined temperature, in particular at room temperature.

The process according to one embodiment is characterized in that at least the bonding composition is heated, in particular using microwaves.

In some embodiments of the process according to one embodiment it is provided that the solvent and/or the radiation absorber, in particular the microwave absorber, is heated such that the thermoplastic polymer material or the polymer material of thermoplastic elastomers at least sectionally and optionally the at least two polymer components at least in the area of the connection surfaces to be joined are transferred into a melt-viscous or melt-liquid state, or that the solvent and/or the radiation absorber, in particular the microwave absorber, is heated such that the duroplastic polymer material or the polymer material of elastomers together with the duroplastic polymer material or the polymer of elastomers of the at least two polymer components to be joined enter crosslinking reactions at least sectionally in the area of the connection surfaces to be joined.

The process according to one embodiment may be performed in such a way that the bonding composition is transferred into a state of a suspension or of a solution through heating, in particular by means of microwave radiation.

Furthermore, the object underlying the invention may be solved through a process for joining polymer components, comprising the steps

a) providing a kit according to one embodiment,

b) optionally providing a heating or radiation device,

c) depositing the bonding composition on a connection surface of the first and/or second polymer component,

d) connecting the first and second polymer component in the area of the connection surface onto which the bonding composition was deposited in step c), and

e) volatizing the solvent of the bonding composition and optionally fusing the polymer material of the bonding composition and of the polymers at the contact surface of the polymer components, in particular under the influence of heat exposure by means of the heating or radiation device, under connection of the first and second polymer component.

Furthermore, the object underlying the invention may be solved through a process for joining polymer components, comprising the steps

a) providing a kit according to one embodiment,

b) optionally providing a microwave emitter,

c) depositing the bonding composition on a connection surface of the first and/or second polymer component,

d) connecting the first and second polymer component in the area of the connection surface onto which the bonding composition was deposited in step c), and

e) exposing the first and second polymer components contacted according to step d), onto which the bonding composition was deposited in step c) to microwave radiation from the microwave emitter under volatilization of the solvent and optionally fusing the polymer material of the bonding composition and of the polymers at the contact surfaces of the polymer components and connection of the first and second polymer component.

Furthermore, the object on which of the invention is based is solved through a motor vehicle component, in particular cover component, a media line and/or a media distributor, actuator, battery encapsulation, headlight cover or sealing and/or decoupling element, in particular produced with the process according to one embodiment , comprising two or more polymer components, each comprising or consisting of thermoplastic polymers which are joined by material engagement by means of a bonding composition according to one embodiment .

The kit according to one embodiment for making a motor vehicle component can in particular be used for the production of a motor vehicle component or for the for the connection of polymer components of thermoplastic polymers of thermoplastic polymers, in particular by material engagement.

Finally, the object underlying to the invention is solved through the use of liquid carboxylic acids, in particular C1- to C6-alkanoic acids, e.g. methanoic acid, acetic acid and/or propionic acid, or of aqueous systems containing at least one liquid carboxylic acid, in particular a C1- to C6-alkanoic acid, e.g. methanoic acid, acetic acid and/or propionic acid, for the connection of the two or more, in particular two, polymer components, each comprising or consisting of thermoplastic polymers, duroplastic polymers, thermoplastic elastomers or elastomers by means of microwave radiation.

The features of the invention disclosed in the foregoing description and in the claims may be essential, both individually and in any combination, for carrying out the invention in its various embodiments.

The present invention is based on the surprising realization that the bonding compounds according to one embodiment can act both as an adhesive for the adhesive bonding of two or more plastic components and can also bring about a “welding” of plastic components by means of microwave radiation. It is also advantageous here that the bonding composition according to one embodiment can be applied without difficulty at room temperature, without the polymer materials present in the solvent already having to be in a dissolved or molten state at room temperature. The use of microwave radiation in the presence of the compositions of the invention not only accelerates the joining process by causing the solvent to volatilize more quickly. In this way, it is also frequently possible to melt the contact surfaces of the plastic components which are to be brought into contact and joined without any problems. Another particularly surprising aspect is the wide range of applications of the bonding compositions of the invention, with which both polar and non-polar polymer materials can be used to bond together plastic components corresponding to these materials. The fact that the solvents used can be quickly removed by using the bonding compositions of the invention or by using the processes of the invention means that the plastic components of the invention are frequently associated with a reduced risk of fire. It is also particularly surprising that even plastic compositions made of very high-melting thermoplastic polymers such as polyamide, PEEK and even polytetrafluoroethylene and polyvinylidene difluoride can be produced with the bonding compounds according to one embodiment. Thermoplastics similar to each other could also be joined in this way.

The features of the invention disclosed in the foregoing description and in the claims may be essential, both individually and in any combination, for carrying out the invention in its various embodiments.

1. A bonding composition for joining two or more polymer components comprising thermoplastic polymers by material engagement, the bonding composition comprising:
at least one solvent ; and
a thermoplastic polymer material at least partially dissolved that is made of the thermoplastic polymers from the two or more polymer components or at least partially miscible with the thermoplastic polymers from the two or more polymer components.

2. The bonding composition of claim 1, wherein the thermoplastic polymers comprises precursors of duroplastic polymers, thermoplastic elastomers, or elastomers.

3. The bonding composition of claim 2, wherein the thermoplastic polymers comprise polar functional groups.

4. The bonding composition of claim 2, wherein the solvent realizes:
a polar solvent and is selected from the group comprising ketones, in particular acetones, cyclohexanone, cyclopentanone, 2-pentanone, 3-pentanone, methyl isobutyl ketone or methyl ethyl ketone; lactones in particular γ-butyrolactone, lactams in particular N-methyl-2-pyrrolidone, nitriles in particular acetonitrile, propane nitrile or benzonitrile; and
nitro compounds, in particular nitroalkanes, e.g. nitromethane, nitroethane, nitropropane or nitrobutane, carboxamides, in particular dimethylformamide, N-methylformamide, formamide, hexamethylphosphoric triamide or dimethylacetamide, urea derivatives, in particular tetramethylurea or dimethylpropyleneurea, sulfoxides, in particular dimethyl sulfoxide, sulfones, in particular sulfolane; carboxylic acids, in particular C1- to C10-alkanoic acids, e.g. for example formic acid, acetic acid or propionic acid, carboxylic esters of formic acid, acetic acid, propionic acid or terephthalic acid, in particular ethyl acetate, isopropyl acetate, n-propyl acetate, t-butyl acetate, n-butyl acetate, octyl acetate, ethyl propionate; anhydrides of formic acid, acetic acid, propionic acid or terephthalic acid, in particular ethyl acetate, isopropyl acetate, n-propyl acetate, t-butyl acetate, n-butyl acetate, octyl acetate, ethyl propionate; anhydrides of formic acid, acetic acid, propionic acid or terephthalic acid; carbonates, in particular dimethyl carbonate, diethyl carbonate or propylene carbonate; alcohols, in particular ethanol, methanol, 1-butanol, 2-butanol, t-butanol, 2-propanol, 1-propanol, 2-methoxyethanol, tetrahydrofuryl alcohol, benzyl alcohol, isoamyl alcohol, 2-pentanol, 2-ethylhexanol or cyclohexanol; polyalcohols, in particular glycerol, ethylene glycol, propylene glycol, 1,4-butanediol, 1,2-propanediol, 1,3-propanediol, di-propylene glycol, diemethylene glycol or diethylene glycol, ether compounds of polyalcohols, in particular ethylene glycol dimethyl ether; aldehydes, in particular furfural; substituted aromatics, in particular chlorobenzene, dichlorobenzene, dinitrobenzene, nitrobenzene, quinoline or pyridine, and any mixtures thereof, wherein each is mixed with a minor amount of water.

5. The bonding composition of claim 2, comprising at least 5 wt.-%, with respect to a total weight of the bonding composition, thermoplastic polymer material, polymer material of thermoplastic elastomers or polymer material of elastomers; wherein the solvent has a composition fraction with respect to a total weight of the bonding composition in the range of 1 wt.-% to 90 wt.-%,wherein components of the bonding composition always amount to 100.0 wt.-%.

6. The bonding composition of claim 2, wherein the polymer material is adapted to the thermoplastic polymers, duroplastic polymers, thermoplastic elastomers or elastomers of the polymer components to be bonded such that, upon a volatilization of the solvent at a predetermined temperature, the two or more polymer components can be joined by material engagement.

7. The bonding composition of claim 6, wherein the solvent comprises a radiation absorber, such as a microwave-absorber, that is configured to heat up under an exposure, wherein the polymer material undissolved in the solvent partially at least sectionally.

8. The bonding composition of claim 2, wherein the thermoplastic polymer material or the thermoplastic polymers of the polymer components which are to be joined is selected from the group consisting of polyolefins, polyamides, polyimides, polyetherimides, polyethers, polysulfones, polyetherpolyurethanes, polyether sulfones, polyetherketones, polyketones, polyesters, polyacrylates, in particular polymethyl methacrylate, polyvinyl chloride, polyvinylidene difluoride, polycarbonate, acrylonitrile/butadiene/styrene copolymers and their arbitrary mixtures, or that the duroplastic polymer material or the duroplastic polymers of the polymer parts to be joined is selected from the group consisting of epoxy resins, methacrylate resins, phenolic resins, polyester resins, e.g. unsaturated polyester resins, polyurethane resins, e.g. two-component polyurethane foams, vinyl ester resins, e.g. unsaturated vinyl ester resins, crosslinked, in particular radiation crosslinked, thermoplastics, e.g. radiation crosslinked polypropylene and their arbitrary mixtures, or that the polymers of the thermoplastic elastomers or the polymer material of the thermoplastic elastomers is selected from the group consisting of thermoplastic elastomers based on ethylene-vinyl acetate copolymers; polyhydroxybutyrate; polylactides; polyetherimides; polyoxymethylene; polycarbonates; polystyrene; impact-modified polystyrene; styrene-based copolymers; olefin-based thermoplastic elastomers; PE/polyester-based thermoplastic elastomers; urethane-based thermoplastic elastomers; polyether block amides; PVC; polyurethanes, in particular thermoplastic polyurethanes, and thermoplastic starch and their arbitrary mixtures, or that the polymers of the elastomers or the polymer material of the elastomers are elastomers selected from the group consisting of acrylonitrile/butadiene/acrylate copolymers, acrylonitrile/chlorinated polyethylene/styrene copolymers, acrylonitrile/methyl methacrylate copolymers, ethylene-ethyl acrylate copolymers, ethylene-propylene copolymers, ethylene-propylene-diene copolymers, vinyl chloride/ethylene copolymers, vinyl chloride/ethylene/methacrylate copolymers, polyisobutylene, polyvinyl butyral, butadiene rubber, butyl rubber, chloroprene rubber, fluororubber, isoprene rubber, natural rubber, silicone rubber, styrene-butadiene rubber and their arbitrary mixtures, in particular based on polyethylene, polypropylene, polyamides, polyethylene terephthalate or polybutylene terephthalate.

9. The bonding composition of claim 2, wherein the thermoplastic polymers of the polymer components match in each case, or the thermoplastic polymer or duroplastic polymer or the polymer of the thermoplastic elastomers or the polymer of the elastomers of the polymer component and the thermoplastic polymer material, the precursor of the duroplastic polymer material, the polymer of the thermoplastic elastomers or the polymer material of the elastomer precursor of the bonding composition match in each case.

10. The bonding composition of claim 2, wherein the thermoplastic polymer of at least one polymer component or the thermoplastic polymer material comprises fibers.

11. The bonding composition of claim 2, wherein the bonding composition comprises at least one microwave-absorber selected from at least one of the following: inorganic alkali metal salts, in particular sodium chloride, potassium fluoride or potassium iodide, optionally in combination with Al₂O₃; inorganic alkaline earth metal salts, in particular calcium chloride; alkali metal salts of carboxylic acids, in particular of alkanoic acids; alkaline earth metal salts of carboxylic acids, in particular of alkanoic acids; spinels, in particular magnetite, CuNi_{0.5}Mn_{1.5}O₄, V₂O₅ or Al₂O₃; metal powders, in particular Ni, Fe or Co; carbon black; silicon carbide; fullerenes; carbon nanotubes; graphite; graphene; activated carbon; organic fillers, in particular viscose fibers, tartaric acid, the salts of tartaric acid or xylitol; and their arbitrary mixtures.

12. The bonding composition of claim 2, wherein the thermoplastic polymers comprise non-polar functional groups.

13. The bonding composition of claim 12, wherein the solvent realizes a nonpolar solvent selected from at least one of: aromatic solvents, in particular toluene, xylene or benzene, aliphatic solvents, in particular cyclohexane, hexane, heptane or pentane, ethereal solvents, in particular diethyl ether or tetrahydrofuran, chlorinated solvents, in particular dichloromethane, chloroform or dichloroethane, fluorinated solvents, or their arbitrary mixtures.

14. The bonding composition of claim 2, wherein the thermoplastic polymers with nonpolar functional groups of the polymer components to be joined are selected from the group consisting of polyolefins, in particular polyethylene or polypropylene, polybutene, polyisobutene, polyetherketones, in particular PEK, PEEK, polyethylene terephthalate, polybutylene terephthalate, polyphenylene sulfide, polyphenylene sulfones, polyacetal, in particular polyoxymethylene, polystyrene, polytetrafluoroethylene and their arbitrary mixtures.

15. The bonding composition of claim 2, wherein the duroplastic polymers realize partially crosslinked duroplastic polymers have a crosslinking degree of maximum 80%, or the duroplastic polymer material realizes partially crosslinked duroplastic material having a crosslinking degree of maximum 80%, or the precursors of the duroplastic polymer material are uncrosslinked.

16. The bonding composition of claim 2, wherein a viscosity, determined at a temperature of 20° C. which lies in the range of 10³ mPas to 8×10⁶ mPas.

17. The bonding composition of claim 2, wherein the polymer material comprises a thermoplastic high temperature polymer material, further wherein the solvent has a permittivity greater than or equal 15, or realizes a protonic solvent.

18. The bonding composition of claim 17, wherein the bonding composition is free of microwave-absorbers aside from the solvent.

19. The bonding composition of claim 2, wherein the polymer material comprises a nonpolar thermoplastic polymer material, wherein the solvent has a permittivity smaller than 15.

20. The bonding composition of claim 19, further comprising at least one microwave-absorber in a range of 0.01 to 5 wt.-%, in each case in relation to the amount of polymer material.

21. The bonding composition of claim 2, wherein the polymer material, in particular the thermoplastic polymer material, is utilized as granules or in powder form.

22. The bonding composition of claim 2, which comprises at least 5 wt.-%, in each case based on the total weight of the bonding composition, of thermoplastic polymer material dissolved in the solvent, of precursor of durpolasts, duroplastic polymer material, polymer material of thermoplastic elastomers, polymer material of precursors of elastomers or polymer material of elastomers,
or at least 5 wt.-%, in each case based on the total weight of the bonding composition, of precursors of duroplastic polymer material dissolved in the solvent, or polymer material of elastomers dissolved in the solvent.

23. The bonding composition of claim 2, wherein the solvent is in an amount which is sufficient to wet the polymer material.

24. The bonding composition of claim 2, wherein the polymer material of elastomers has a crosslinking degree not above 60%, or
the polymer material comprises an uncrosslinked rubber or an uncrosslinked rubber mixture or an uncrosslinked precursor of a duroplast.

25. The bonding composition of claim 2, wherein the polymer material comprises at least one thermoplastic polymer, wherein the solvent comprises a C1 to C6 alkanoic acid, in admixture with a minor amount of water.

26. The bonding composition of claim 2, wherein the polymer material comprises polytetrafluoroethylene or polyvinylidene difluoride; wherein the solvent comprises a fluorinated solvent.

27. The bonding composition of claim 2, wherein the polymer material comprises polyether polyurethane and the solvent further comprises diemthylformamide, dimethylacetamide or acetone.

28. The bonding composition of claim 2, wherein the polymer material comprises at least one non-polar thermoplastic polymer, wherein the solvent comprises hexane, heptane or cyclohexane.

29. The bonding composition of claim 2, wherein the polymer material comprises at least one non-polar thermoplastic polymer, wherein the solvent comprises acetone.

30. The bonding composition of claim 2, wherein the polymer material comprises polymethyl methacrylate or polycarbonate, further wherein the solvent comprises nitroalkanes, including nitromethane, nitroethane, nitropropane or nitrobutane, acetone, dichloromethane, ethyl acteate, n-propyl and n-butyl acetate, toluene or xylene.

31. An apparatus for producing a polymer part comprising:
at least one first polymer component;
at least one second polymer component;
wherein each the at least one first polymer component and the at least one second polymer component are both comprising a polymer material formed from thermoplastic polymers, duroplastic polymers, thermoplastic elastomers, or elastomers, and comprising a bonding composition for joining the at least one first polymer component and the at least one second polymer component by material engagement;
wherein the bonding composition comprises at least one solvent and the polymer material.

32. The apparatus of claim 31, wherein the apparatus comprises a kit for a motor vehicle component, such as a cover component, a media line, a media distributor, actuator, battery encapsulation, headlight cover, sealing, or decoupling element.

33. The apparatus of claim 31, wherein the at least one solvent for the bonding composition further comprises at least one polar solvent and an amount of at least one thermoplastic polymer material having polar functional groups, wherein the amount of the at least one thermoplastic polymer material is at least partially dissolved in the at least one polar solvent.

34. The apparatus of claim 31, wherein the at least one solvent for the bonding composition further comprises at least one non-polar solvent, and an amount of at least one thermoplastic polymer material having non-polar functional groups, wherein the amount of the at least one thermoplastic polymer material is at least partially dissolved in the at least one non-polar solvent or at least one microwave absorber.

35. The apparatus of claim 31, wherein the bonding composition is introduced between or applied to respective bonding surfaces of the polymer components, wherein a bond between the first polymer component, the polymer material of the bonding composition and the second polymer component is effected by volatilization of the solvent.

36. The apparatus of claim 35, wherein the volatilization of the solvent occurs at a predetermined temperature.

37. The apparatus of claim 31, wherein the bonding composition is heated, such as by using microwaves.

38. The apparatus of claim 31, wherein the solvent or a radiation absorber is heated such that the polymer material at least sectionally and the at least two polymer components in an area of the connection surfaces to be joined are transferred into a melt-viscous or melt-liquid state.

39. The apparatus of claim 31, wherein the radiation absorber comprises a microwave absorber and is heated such that the polymer material of the at least two polymer components to be joined enter crosslinking reactions at least sectionally in an area of the connection surfaces to be joined.

40. The apparatus of claim 31, wherein the bonding composition is transferred into a state of a suspension or a state of a solution through heating, such as by microwave radiation.

41. A method comprising:
depositing a bonding composition on a connection surface of a first polymer component to be joined to a second polymer component, wherein the first polymer component and the second polymer component are made from a polymer material and the bonding composition comprises at least one solvent and the polymer material;
connecting the first polymer component and the second polymer component in the area of the connection surface onto which the bonding composition was deposited;
volatizing the solvent of the bonding composition; and
fusing, under heat exposure, the polymer material of the bonding composition and of the polymers at the contact surface of the polymer components.
